(19) United States
(12) Patent Application Publication
(10) Pub. No.: US 2006/0263157 A1
(43) Pub. Date: Nov. 23, 2006

(54) Carbide extension rod for use of processing tools

(76) Inventor: Chao Nan Yeh, Changhua Hsien (TW)

Correspondence Address: Alan D. Kamrath;NIKOLAI & MERSEREAU, P.A., International Centre, Suite 820, 900 Second Avenue South, Minneapolis, MN, 55402, US

(21) Appl. No.: 11/130,169

(22) Filed: May 17, 2005

(51) Int. Cl. B23B 51/14

(52) U.S. Cl. 408/239 R

(57) ABSTRACT

A carbide extension rod for a processing tool has a shank integrally molded of carbide material. The shank has an uniform hardness and has one end face formed with a stepwise engaging cavity. The processing tool has a tooling body secured to the shank. The tooling body has a hardness at least equivalent to that of the shank and has one end face formed with a stepwise coupling end received in the engaging cavity. Thus, the shank has an uniform hardness so that the extension rod will not be cracked or broken when the tooling body of the processing tool is mounted onto the shank of the extension rod.

### BACKGROUND OF THE INVENTION

The present invention is related to a carbide extension rod for use of processing tools, comprising an extension rod integrally molded of carbide material and an engaging cavity disposed at one end of the extension rod for the secure registration of a processing tool therewith wherein the shank of the extension rod is integrally molded of carbide material with uniform hardness, and the engaging cavity is processed via electric discharge and grinding operations at one end of the extension rod thereon so that the extension rod, without any other engaging portion with a locking hole of different hardness welding-joined thereto, won't easily get cracked or broken when a tooling body of the processing tool thereof is processed to tightly mount thereto, facilitating more durable application and longer using lifetime of the present invention thereof.

Please refer to FIG. 1. A conventional extension rod structure for use of processing tools comprises an extension rod 10 to be reciprocally engaged with different types of tooling bodies 20 each having a coupling end 21 disposed thereon. The extension rod 10 is made up of a main shank 11 combined with an engaging portion 12 having a locking hole 121 defining therein.

However, there are some disadvantages to the above-mentioned conventional extension rod structure. First, due to the technical difficulty in the processing of carbide material as well as for the convenience of processing thereof, the engaging portion 12 of the extension rod 10 is made of normal steel material characterized by a lower hardness, and welding-joined to the main shank 11 made of carbide material characterized by a higher hardness. When the coupling end 21 of the tooling body 20 is processed to engage with the locking hole 121 of the engaging portion 12 thereof, the huge assembly force in the combination thereof tends to produce cracks or break at the adjoining face A between the main shank 11 and the engaging portion 12 thereof, and cause damages to the extension rod 10, which can uneconomically increase the cost thereof. Second, the coupling end 21 of the tooling body 20 is reciprocally registered with the locking hole 121 of the engaging portion 12 thereof. And the hardness of the tooling body 20 is higher than that of the engaging portion 12 made of normal steel material. Over long time of application thereof, the locking hole 121 of the engaging portion 12 can be easily deformed and fail to securely fix and stably hold the coupling end 21 of the tooling body 20 thereof in place, which can reduce its using lifetime and cause inconvenience in application thereof.

### SUMMARY OF THE PRESENT INVENTION

It is, therefore, the primary purpose of the present invention to provide a carbide extension rod for use of processing tools, comprising an extension rod integrally molded of carbide material, and an engaging cavity processed via electric-discharge and grinding operations at one end of the extension rod thereon for the secure registration of a processing tool therewith wherein the shank of the extension rod is integrally made of carbide material with the engaging cavity thereof disposed at one end thereon, and characterized by uniform hardness at least equivalent to that of the processing tool; therefore, the extension rod, without any other engaging portion with a locking hole of different hardness welding-joined thereto, won't easily get cracked or broken when a tooling body of the processing tool is processed to tightly mount and stably locate thereto, facilitating more durable application and longer using lifetime of the present invention thereof.

### BRIEF DESCRIPTION OF THE DRAWINGS

FIG. 1 is an assembled cross sectional view of a conventional extension rod structure.

FIG. 2 is an exploded perspective view of the present invention.

FIG. 3 is an assembled cross sectional view of the present invention.

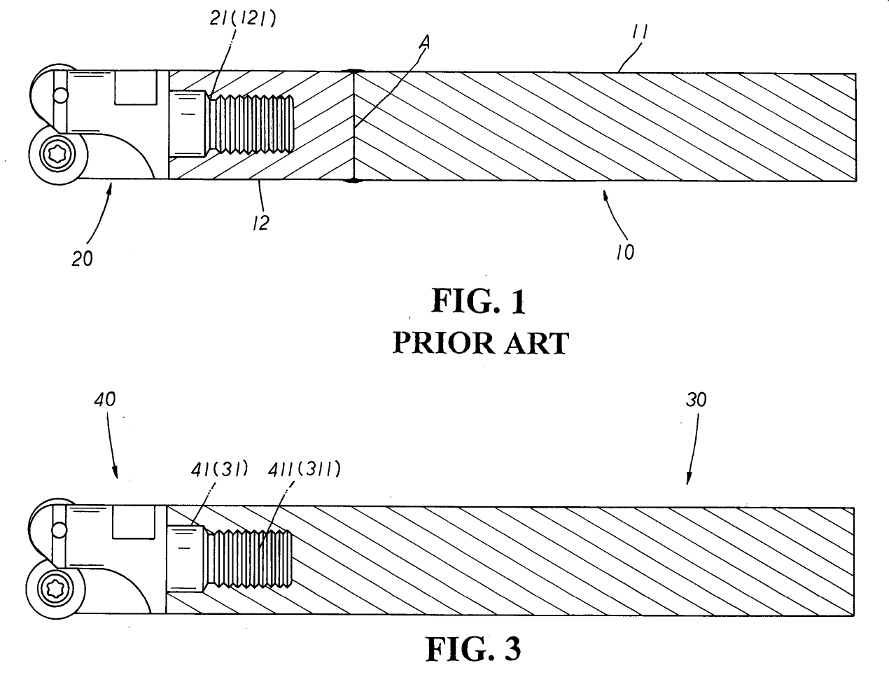

### DETAILED DESCRIPTION OF THE PREFERRED EMBODIMENTS

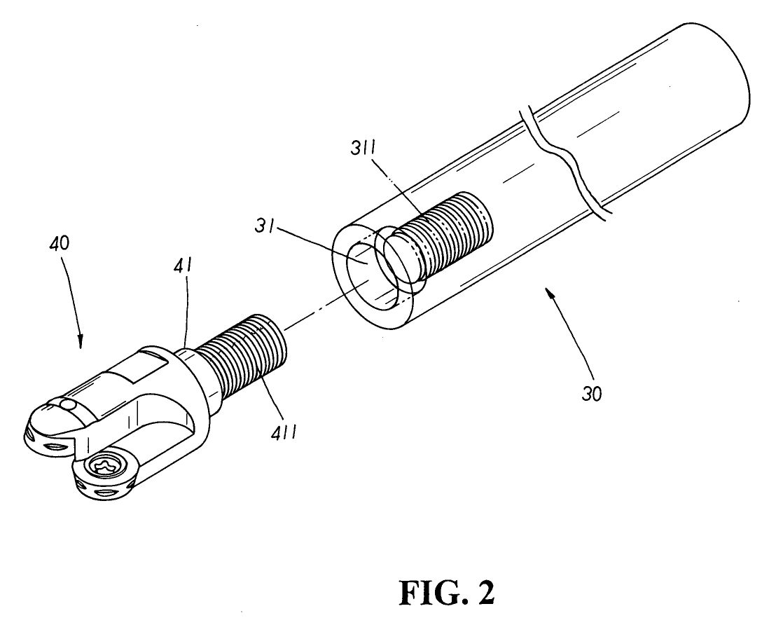

Please refer to FIGS. 2 to 3 inclusive. The present invention is related to a carbide extension rod for use of processing tools, comprising an extension rod 30 whose shank is integrally molded of carbide material characterized by uniform hardness, and an engaging cavity 31 processed via electric discharge and grinding operations at one end surface of the extension shank 30 thereon. The engaging cavity 31 thereof, made in a stepwise shape, is composed of an internally threaded section 311 defining the smaller diameter step thereof to be reciprocally registered with an externally threaded section 411 of a coupling end 41 extending at one side of a tooling body 40 of a wide range and different sizes of processing tools. Therefore, the extension rod 30, without any other engaging portion with a locking hole of different hardness welding-joined at one end thereto, is uniformly molded with identical hardness so that when the tooling body 40 is processed to tightly mount thereto, the extension rod 30 won't easily get cracked or broken so as to reinforce the secure engagement of the coupling end 41 with the engaging cavity 31 thereof and stably hold the tooling body 40 in place thereby, facilitating more durable application and longer using lifetime of the present invention thereof.

Preferably, the shank of the extension rod 30 is equipped with hardness at least equivalent to that of the processing tool engaged therewith. Otherwise, the shank of the extension rod 30 should be made in hardness higher than that of the processing tool thereof.

1. A carbide extension rod in combination with a processing tool, comprising:
an extension rod having a shank integrally molded of carbide material, the shank of the extension rod having an uniform hardness, the shank of the extension rod having one end face formed with a stepwise engaging cavity having an internally threaded section;
a processing tool having a tooling body secured to the shank of the extension rod, the tooling body of the processing tool having a hardness at least equivalent to that of the shank of the extension rod, the tooling body of the processing tool having one end face formed with a stepwise coupling end received in the engaging cavity of the shank of the extension rod, the coupling end of the tooling body of the processing tool having an externally threaded section screwed into the internally threaded section of the shank of the extension rod.

2. (canceled)

3. (canceled)

4. (canceled)
